(19) United States
(12) Patent Application Publication
(10) Pub. No.: US 2006/0121754 A1
(43) Pub. Date: Jun. 8, 2006

(54) Conforming Lid Socket for Leaded Surface Mount Packages

(76) Inventor: Milos Krejcik, Lasvegas, NV (US)

Correspondence Address: MILOS KREJCIK, 6275 SADDLE TREE DRIVE, LAS VEGAS, NV, 89118, US

(21) Appl. No.: 10/707,383

(22) Filed: Dec. 9, 2003

Related U.S. Application Data
(60) Provisional application No. 60/320,275, filed on Jun. 13, 2003.

(51) Int. Cl. H01R 12/00

(52) U.S. Cl. 439/73

(57) ABSTRACT

The effects of the invention Conforming Lid Socket are accomplished by the use of a firm lid with conforming surface which presses the package leads towards contacts (pads) on the contact plate. The plate can be a rigid substrate with contacts and pins, a rigid printed circuit board or even flexible printed circuit board. The package leads are placed directly on those contacts (pads) pads. The lid is firm, with conforming surface at the compression points, hence it can compensate for varying thickness of individual leads and can guarantee sufficient pressure on every lead individually. A support plate may be required for the use on normal thickness rigid printed circuit boards, and is necessary for the use on flexible printed circuit boards. The need for the use of the support plate is based upon the stiffness of the contact plate and the size of the package.

### BACKGROUND OF INVENTION

1. Field of the Invention

This invention relates to Leaded Surface Mount Packages and a Socket which provides reliable contact for all it's leads. The invention Conforming Lid Socket provides a sufficient pressure on each lead of the package against rigid, immovable, contact. The invention simplifies socket design, reduces the cost of manufacturing and improves socket's electrical performance.

2. Prior Art of the Invention

Conventionally, various sockets have been designed with contacts made of springs shaped as modified letters U or C, or using spring-loaded (pogo) pins. The package leads either rest on the socket contacts and are pressed down by a socket lid, (“hinge-lid”, also called “clam-shell design”), or the leads rest on plastic rim in the socket and are pressed down by pre-tensioned contacts (“Open-top design”), or the C shaped spring contact provides both the bottom contact and the top pre-tensioned contact—a variation of “Open-top” socket.

Some conventional sockets do not use individual contact pins the contacts are pads on a printed circuit board. A conductive polymer (in Z-direction only) is placed over the pads, the package is placed on the polymer. The lid puts pressure on the leads, compresses the polymer and thus compensates for the differing thickness of individual leads.

All conventional sockets use conforming contacts—springs or elastomers. This approach results in complex design and introduces unwanted parasitic inductance, capacitance and in the case of polymer design, resistive components.

### SUMMARY OF INVENTION

invention Conforming Lid Socket substantially eliminates drawbacks and limitations of conventional sockets for electronic devices in leaded surface mount packages and provides compact and economical sockets with better electrical performance. Electronic device in the leaded surface mount package can be Integrated Circuits (IC), discrete semiconductor (Discrete), passive component (such as resistor and capacitor) or electromechanical device (such as relays).

### BRIEF DESCRIPTION OF DRAWINGS

Three dimensional view showing Conforming Lid Socket according to a first embodiment of the present invention. Three dimensional view showing Conforming Lid Socket according to a second embodiment of the present invention Cross sectional view showing Conforming Lid Socket according to a third embodiment of the present invention

### DETAILED DESCRIPTION

### FIRST EMBODIMENT

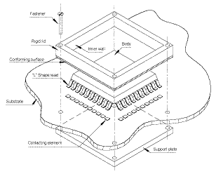

FIG. 1, Three dimensional view showing Conforming Lid Socket according to a first embodiment of the present invention. As shown in this figure the Conforming Lid Socket of this embodiment has RIGID LID with an opening hawing INNER WALL on each side of a surface mount package BODY and “L” SHAPE LEADS. The BODY is inserted into this opening, with a vertical element of the “L” SHAPE LEADS pressing against the INNER WALLS, forming a tight fit. The BODY is pushed in until the bottom element of the “L” SHAPE LEADS presses against the CONFORMING SURFACE of the RIGID LID. The RIGID LID and BODY subassembly is fastened against the SUBSTRATE carrying the CONTACTING ELEMENTS and optional application circuitry. The SUPPORT PLATE is used to maintain proper connection between the CONTACTING ELEMENT and “L” SHAPED LEADS. Every BODY type requires different RIGID LID and corresponding SUBSTRATE including specific CONTACTING ELEMENT pattern.

### SECOND EMBODIMENT

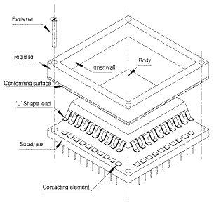

FIG. 2, Three dimensional view showing Conforming Lid Socket according to a second embodiment of the present invention. As shown in this figure the Conforming Lid Socket of this embodiment is identical to FIG. 1, with the exception of the SUBSTRATE which has same size as the RIGID LID and the CONTACTING ELEMENTS are connected to corresponding pins of specific pattern. In this embodiment the Conforming Lid Socket may be inserted into appropriate socket or be soldered on printed circuit board.

### THIRD EMBODIMENT

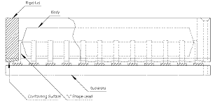

FIG. 3, Cross sectional view showing Conforming Lid Socket according to a third embodiment of the present invention. As shown in this figure the Conforming Lid Socket of this embodiment has all components consisting of RIGID LID, BODY and SUBSTRATE showing their final assembled placement at which the CONFORMING SURFACE is pressing against bottom element of the “L” SHAPE LEADS and CONTACTING ELEMENT.

1. A Conforming Lid Socket for connection to the leads of a surface mount package, said package having a body and each said lead is formed in “L” shape having a downwardly extending section proximate a side of said body and outwardly extending section proximate a bottom of said body,
said Conforming Lid Socket comprising:
a rigid lid having a thickness and opening that allow encase specific surface mount package, said opening having downwardly extending wall proximate a side of said body, said rigid lid having bottom flat conforming surface proximate a bottom of said body,
a plurality of said lead downwardly extending section pressing against said wall, said conforming surface pressing against said lead outwardly extending section having a bottom connection surface,
a plurality of said connection surface connecting to a substrate bearing contacting element, said circuit having a thickness and a bottom surface proximate a bottom of said body,
a rigid support plate having a thickness and a top surface proximate a bottom of said circuit, said top surface pressing against said bottom surface.

2. The Conforming Lid Socket of [c1] having said substrate bearing contacting element on a production printed rigid circuit board and said rigid support plate to keep said rigid circuit board straight.

3. The Conforming Lid Socket of [c1] having said substrate bearing contacting element on a production printed flexible circuit board and said rigid support plate to keep said flexible circuit board straight.

4. The Conforming Lid Socket of [c1] having said substrate bearing contacting element on a production printed extra thick circuit board without said rigid support plate.

5. The Conforming Lid Socket of [c1] having said substrate bearing contacting element connected to a pin, a plurality of said pin having virtually any footprint required for surface mount or through-hole applications.

6. The Conforming Lid Socket of [c1] wherein said connection surface and said contacting element having negligible parasitic inductance compared to conventional sockets with conforming contact pins.

7. The Conforming Lid Socket of [c1] wherein said connection surface and said contacting element having negligible parasitic capacitance compared to conventional sockets with conforming contact pins.

8. The Conforming Lid Socket of [c1] wherein said connection surface and said contacting element having no additional resistance compared to conventional sockets with conductive polymer.
